(19) United States
(12) Patent Application Publication
(10) Pub. No.: US 2025/0028216 A1
(43) Pub. Date: Jan. 23, 2025

(54) SWITCHABLE ELECTROPHORETIC LIGHT MODULATOR HAVING REDUCED APERTURE DIFFRACTION

(71) Applicant: E INK CORPORATION, Billerica, MA (US)

(72) Inventors: Bryan DUNN, Medford, MA (US); Kenneth R. CROUNSE, Somerville, MA (US); Dirk HERTEL, Quincy, MA (US); George G. HARRIS, Woburn, MA (US); Yu XIA, Acton, MA (US)

(21) Appl. No.: 18/746,222

(22) Filed: Jun. 18, 2024

Related U.S. Application Data
(60) Provisional application No. 63/527,361, filed on Jul. 18, 2023.

(51) Int. Cl. G02F 1/167; G02F 1/1675; G02F 1/16755; G02F 1/1676; G02F 1/1681; G02F 1/1685

(52) U.S. Cl. CPC G02F 1/167; G02F 1/16755; G02F 1/1676; G02F 1/1681; G02F 1/1685; G02F 2001/1678

(57) ABSTRACT

Switchable light modulator suppresses aperture and array diffraction, reducing blurring of images viewed through films. The light modulator includes a first light-transmissive substrate, a first electrode on one side of the first light-transmissive substrate, a second light-transmissive substrate, a second electrode on one side of the second light-transmissive substrate, a light-transmissive polymeric structure between the first electrode and the second electrode, and an electro-optic medium contained in cells in the polymeric structure. The polymeric structure includes a base and a wall structure defining the cells. Each cell includes wells on the base. The wall structure includes pillar structures and linking wall elements connecting adjacent pillar structures. The pillar structures include distal surfaces parallel to the base arranged with the wells in a given pattern. Application of a driving voltage between the first and second electrodes causes the electro-optic medium to switch between a light-absorbing state and a light-transmissive state.

### RELATED APPLICATIONS

This application claims priority to U.S. Provisional Patent Application No. 63/527,361 filed Jul. 18, 2023, which is incorporated by reference in its entirety. All patents and publications disclosed herein are also incorporated by reference in their entireties.

### BACKGROUND

This invention relates to electrophoretic light modulating films, which modulate the amount of light or other electro-magnetic radiation passing through an electrophoretic medium. In some instances, the light will pass completely through the film (i.e., from top to bottom). In other instances, the light may pass through the electrophoretic medium, reflect/scatter off a surface, and return through the medium a second time (i.e., from top to bottom surfaces and back to top.) Such films can be incorporated into displays, signs, variable transmission windows, mirrors, displays, and similar devices. Typically the films have an “open” state, in which one or more sets of pigment particles are isolated to the side or in wells, etc., so that most of the incident light can pass through the medium, and a “closed” state, in which one or more sets of pigment particles are distributed through the medium to absorb some or all of the incident light.

For example, U.S. Pat. No. 10,067,398 discloses an electrophoretic light attenuator comprising a cell including a first substrate, a second substrate spaced apart from the first substrate, a layer arranged between the substrates containing an electrophoretic ink, and a monolayer of closely packed protrusions projecting into the electrophoretic ink and arranged adjacent a surface of the second substrate. The protrusions have surfaces defining a plurality of depressions between adjacent protrusions. The electrophoretic medium layer (ink layer) includes charged particles of at least one type, the particles being responsive to an electric field applied to the cell to move between a first extreme light state, in which the particles are maximally spread within the cell so as to lie in the path of light through the cell and thus strongly attenuate light transmitted from one substrate to the opposite substrate, and a second extreme light state, in which the particles are maximally concentrated within the depressions so as to let light be transmitted. The total area corresponding to the concentrated particles in the depressions is a fraction of the total face area.

Devices of this type rely at least in part on the shape of their non-planar, polymer structure to concentrate absorbing charged particles (e.g., black particles) in an electrophoretic ink in a transparent light state thereby forming (or exposing) light apertures (i.e., transmitting areas) and light obstructions (i.e., strongly absorbing areas).

For convenience, the term “light” will normally be used herein, but this term should be understood in a broad sense to include electro-magnetic radiation at non-visible wavelengths. For example, as the present invention may be applied to provide windows that can modulate infra-red radiation for controlling temperatures within buildings or vehicles. More specifically, this invention relates to light modulators that use particle-based electrophoretic media to control light modulation. Examples of electrophoretic media that may be incorporated into various embodiments of the present invention include, e.g., the electrophoretic media described in U.S. Pat. Nos. 10,809,590 and 10,983,410, the contents of both of which are incorporated by reference herein in their entireties.

Prior art solutions that have a polymer structure in the fluid or gel layer suitable for use with the invention include U.S. Pat. No. 8,508,695 to Vlyte Innovations Ltd., which discloses dispersing fluid droplets (1 to 5 microns in diameter) in a continuous polymer matrix that is cured in place to both substrates, to contain liquid crystals. Additionally, U.S. Pat. No. 10,809,590 to E Ink Corporation discloses microencapsulating fluid droplets and deforming them to form a monolayer of close packed polymer shells in a polymer matrix on one substrate and subsequently applying an adhesive layer to bond the capsule layer to a substrate. Also, European Patent Application Publication EP1264210 to E Ink California discloses embossing a micro-cup structure on one substrate, filling the cups with fluid having polymerizable components and polymerizing the components to form a sealing layer on the fluid/cup surface, then applying an adhesive layer to bond to the second substrate. Additionally, EP2976676 to Vlyte Innovations Ltd. discloses forming a wall structure on one substrate, coating the tops of walls with adhesive, filling the cavities defined by the walls with fluid, and polymerizing the adhesive to bond the tops of walls to the opposing substrate. EP3281055 describes a flexible device including solid polymer microstructures embedded in its viewing area and the microstructures are on both substrates. The microstructures join (i.e., fasten) the substrates of the device to each other by engaging with each other over a length orthogonal to the substrates. The joined microstructures incorporate a wall structure that divides a device's fluid layer into a monolayer of discrete volumes contained within corresponding cavities. This provides the device with significant structural strength. In the method described, mating microstructures (i.e., male and female parts) are formed on each substrate, then precisely aligned with each other and joined in a press fit that also seals the fluid layer in the cavities.

Particle-based electrophoretic displays, in which a plurality of charged particles move through a suspending fluid under the influence of an electric field, have been the subject of intense research and development for a number of years. Such displays can have attributes of good brightness and contrast, wide viewing angles, state bistability, and low power consumption when compared with liquid crystal displays. The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, e.g., at least four times, the minimum duration of the addressing pulse required to change the state of the display element. It is shown in published U.S. Patent Application Publication No. 2002/0180687 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

As noted above, electrophoretic media require the presence of a suspending fluid. In most prior art electrophoretic media, this suspending fluid is a liquid, but electrophoretic media can be produced using gaseous suspending fluids; see, e.g., Kitamura, T., et al., “Electrical toner movement for electronic paper-like display”, IDW Japan, 2001, Paper HCS1-1, and Yamaguchi, Y, et al., “Toner display using insulative particles charged triboelectrically”, IDW Japan, 2001, Paper AMD4-4). See also European Patent Applications 1,429,178; 1,462,847; and 1,482,354; and International Applications WO 2004/090626; WO 2004/079442; WO 2004/077140; WO 2004/059379; WO 2004/055586; WO 2004/008239; WO 2004/006006;WO 2004/001498; WO 03/091799; and WO 03/088495. Such gas-based electrophoretic media appear to be susceptible to the same types of problems due to particle settling as liquid-based electrophoretic media, when the media are used in an orientation that permits such settling, e.g., in a sign where the medium is disposed in a vertical plane. Indeed, particle settling appears to be a more serious problem in gas-based electrophoretic media than in liquid-based ones since the lower viscosity of gaseous suspending fluids as compared with liquid ones allows more rapid settling of the electrophoretic particles.

Numerous patents and applications assigned to or in the names of the Massachusetts Institute of Technology (MIT) and E Ink Corporation, E Ink California, LLC, and related companies describe various technologies used in encapsulated and microcell electrophoretic and other electro-optic media. Encapsulated electrophoretic media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. In a microcell electrophoretic display, the charged particles and the fluid are not encapsulated within microcapsules but instead are retained within a plurality of cavities formed within a carrier medium, typically a polymeric film. The technologies described in these patents and applications include:
(a) Electrophoretic particles, fluids and fluid additives; see, e.g., U.S. Pat. Nos. 7,002,728 and 7,679,814;
(b) Capsules, binders and encapsulation processes; see, e.g., U.S. Pat. Nos. 6,922,276 and 7,411,719;
(c) Microcell structures, wall materials, and methods of forming microcells; see for example U.S. Pat. Nos. 7,072,095 and 9,279,906;
(d) Methods for filling and sealing microcells; see, e.g., U.S. Pat. Nos. 7,144,942 and 7,715,088;
(e) Films and sub-assemblies containing electro-optic materials; see, e.g., U.S. Pat. Nos. 6,982,178 and 7,839,564;
(f) Backplanes, adhesive layers and other auxiliary layers and methods used in displays; see, e.g., U.S. Pat. Nos. 7,116,318 and 7,535,624;
(g) Color formation and color adjustment; see, e.g., U.S. Pat. Nos. 7,075,502 and 7,839,564;
(h) Methods for driving displays; see, e.g., U.S. Pat. Nos. 7,012,600 and 7,453,445;
(i) Applications of displays; see, e.g., U.S. Pat. Nos. 7,312,784 and 8,009,348; and
(j) Non-electrophoretic displays, as described in U.S. Pat. No. 6,241,921 and U.S. Patent Applications Publication No. 2015/0277160; and applications of encapsulation and microcell technology other than displays; see, e.g., U.S. Patent Application Publications Nos. 2015/0005720 and 2016/0012710.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see, e.g., the aforementioned U.S. Patent Application Publication No. 2002/0131147. Accordingly, for purposes of the present application, such polymer-dispersed electrophoretic media are regarded as sub-species of encapsulated electrophoretic media.

A related type of electrophoretic display is a so-called “microcell electrophoretic display”. In a microcell electrophoretic display, the charged particles and the suspending fluid are not encapsulated within microcapsules, but instead are retained within a plurality of cavities formed within a carrier medium, typically a polymeric film. See, e.g., International Application Publication No. WO 02/01281, and published U.S. Application Publication No. 2002/0075556, both assigned to SiPix Imaging, Inc.

Electrophoretic media are often opaque (since, e.g., in many electrophoretic media, the particles substantially block transmission of visible light through the display) and operate in either a light-absorptive or a light-reflective mode. However, electrophoretic devices can also be made to operate in a so-called “shutter mode,” in which one display state is substantially opaque and one is substantially light-transmissive. See, e.g., the aforementioned U.S. Pat. Nos. 6,130,774 and 6,172,798, and U.S. Pat. Nos. 5,872,552; 6,144,361; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode. In particular, when this “shutter mode” electrophoretic device is constructed on a transparent substrate, it is possible to regulate transmission of light through the device.

An encapsulated or microcell electrophoretic display typically does not suffer from the clustering and settling failure mode of traditional electrophoretic devices and provides further advantages, such as the ability to print or coat the display on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition; and other similar techniques.) Thus, the resulting display can be flexible. Further, because the display medium can be printed (using a variety of methods), the display itself can be made inexpensively.

One potentially important market for electrophoretic media is windows with variable light transmission. As the energy performance of buildings becomes increasingly important, electrophoretic media could be used as coatings on windows to enable the proportion of incident radiation transmitted through the windows to be electronically controlled by varying the optical state of the electrophoretic media. Effective implementation of such “variable-transmissivity” (“VT”) technology in buildings is expected to provide (1) reduction of unwanted heating effects during hot weather, thus reducing the amount of energy needed for cooling, the size of air conditioning plants, and peak electricity demand; (2) increased use of natural daylight, thus reducing energy used for lighting and peak electricity demand; and (3) increased occupant comfort by increasing both thermal and visual comfort. Even greater benefits would be expected to accrue in an automobile or other vehicle, where the ratio of glazed surface to enclosed volume is significantly larger than in a typical building. Specifically, effective implementation of VT technology in automobiles is expected to provide not only the aforementioned benefits but also (1) increased motoring safety, (2) reduced glare, (3) enhanced mirror performance (by using an electro-optic coating on the mirror), and (4) increased ability to use heads-up displays. Other potential applications of VT technology include privacy glass and glare-guards in electronic devices.

One of the drawbacks of shuttered electrophoretic systems has been diffraction patterns that can cause an image viewed through the medium to look “wavy” and/or create star patterns and/or refractive rainbow when bright points are viewed through the system. There is a need for a solution that minimizes or avoids the perception of a diffraction pattern about a bright light source viewed through an electrophoretic device that uses a non-planar, polymer structure in forming an optically-transparent light state. In a diffraction pattern, light and dark bands surround a bright light source, greatly magnifying its apparent size. It becomes perceivable when light levels either side of a device are significantly different such as when viewing street lights, traffic lights, or the headlights of a car, at night time.

Diffraction, as used herein, refers to various phenomena arising from the wave nature of light and occurs in embodiments at the edge of light transmitting areas where light waves become obstructed (or absorbed) by black charged particles. The diffraction phenomenon can be described as the apparent bending of light waves around an obstruction (i.e., concentrated black charged particles) and the spreading out of light waves past small openings (i.e., apertures free of charged particles).

In devices that provide periodically spaced apertures or obstructions (e.g., devices having hexagonal-close-packing of protrusions), a complex diffraction pattern of varying intensity (i.e., light and dark bands) results about brightly lit objects viewed through the device. The complex pattern is due to the superposition, or interference, of different parts of a light wave that travels to a viewer by different paths and is similar to diffraction patterns formed by diffraction gratings having a similar shape of slit. When viewing an object through a device, the smaller the dimension of apertures (or obstructions) in the array, the wider the diffraction bands.

Many of the applications contemplated herein, such as variable light transmittance films for use in windows, are viewed from a distance of one meter or more and the diffraction pattern is generally known as Fraunhofer diffraction (i.e., far field conditions). If the object and viewing distances are less than one meter, then the pattern (where present) can fulfil the conditions for Fresnel diffraction (i.e., near-field diffraction), see the relevant entries in www.wikipedia.org for example.

In U.S. Patent Publication No. 2021/0072578, the perception of diffraction is reduced in an electrophoretic device by arranging its microstructures aperiodically. The aperiodic microstructures are in a monolayer. For example, the microstructures have differences in surface shape in at least one aspect including center-to-center distance, cross-sectional area, cross-sectional geometric form, or orientation. Light is diffracted into a plurality of directions by the aperiodic microstructures, thereby reducing perceived diffraction patterns when an observer views a light source through the light attenuator. But diffraction is not suppressed; its perception is changed from being a characteristic diffraction pattern defined by the aperture or obstruction to a halo (i.e., randomized diffraction).

Typically, in such devices, a plurality of apertures (or obstructions) in the first light state, i.e., the open state, form an array (i.e., periodically spaced) across a viewing face. The presence of a hard transition edge creates a complex diffraction pattern of varying intensity (i.e., light and dark bands) when brightly lit objects are viewed through the device. This can be unpleasant, even startling, when a viewer is looking through the device at, e.g., a traffic light. The complex pattern is due to the superposition, or interference, of different parts of a light wave that travels to a viewer by different paths. The relative intensity of the positions of the diffraction pattern/order/band about the central bright object decreases with increasing position. In a plot of intensity/irradiance versus distance from the center of a light source in the far field and seen through an array of apertures, the diffraction positions/orders are apparent as ripples. In a Point Spread Function (PSF) plot the diffraction pattern is shown as dark and bright regions (or differently colored regions). For example, the PSF plot for circular apertures comprises a bright central disc known as the Airy disc with concentric dark and bright bands outside this area forming a diffraction pattern.

A need exists for electrophoretic light modulating films that effectively suppress aperture and array diffraction and thereby reduce blurring of images viewed through the films.

### SUMMARY

A switchable light modulator in accordance with one or more embodiments includes a first light-transmissive substrate, a first electrode on one side of the first light-transmissive substrate, a second light-transmissive substrate, a second electrode on one side of the second light-transmissive substrate, a light-transmissive polymeric structure between the first electrode and the second electrode, and an electro-optic medium contained in each of a plurality of cells in the polymeric structure. The polymeric structure includes a base and a wall structure extending from the base defining the plurality of cells. Each cell includes a plurality of wells on the base. The wall structure comprises a plurality of pillar structures and linking wall elements connecting adjacent pillar structures. The pillar structures include distal surfaces parallel to the base. The distal surfaces are arranged with the plurality of wells in a given pattern. Application of a driving voltage between the first and second electrodes causes the electro-optic medium to switch between a first light-absorbing state and a second light-transmissive state.

In one or more embodiments, the electro-optic medium comprises charged pigment particles dispersed in a non-polar solvent, and the electro-optic medium switches between the first light-absorbing state and the second light-transmissive state by moving between a distributed particle state and an assembled particle state.

In one or more embodiments, when the electro-optic medium is in the second light-transmissive state, the charged pigment particles are collected in the wells of the polymeric structure, and when the electro-optic medium is in the first light-absorbing state, the charged pigment particles are distributed across the cells.

In one or more embodiments, the distal surfaces of the pillar structures are blackened.

In one or more embodiments, distal surfaces of the linking wall elements are light-transmissive.

In one or more embodiments, the electro-optic medium is bistable.

In one or more embodiments, the given pattern is a blue noise generated pattern or a dither mask pattern.

In one or more embodiments, the switchable light modulator further comprises a sealing layer applied over the polymeric structure to seal the plurality of cells, wherein the pillar structures provide structural support and sealing adhesion to the sealing layer.

In one or more embodiments, the distal surfaces of the pillar structures are similar in size and shape to the plurality of wells.

In one or more embodiments, the distal surfaces of the pillar structures are dissimilar in size or shape to the plurality of wells.

In one or more embodiments, said polymeric structure is embossed.

In one or more embodiments, the first light transmissive substrate or the second light transmissive substrate comprise polymers including acrylate, methacrylate, vinylbenzene, vinylether, or multifunctional epoxides.

In one or more embodiments, the switchable light modulator is incorporated in a windshield, window, glasses, googles, or visor.

In one or more embodiments, the switchable light modulator is incorporated in an information display system comprising a transparent substrate and a projector configured to project information on the switchable light modulator. The projector may be a near-to-eye projector.

These and other aspects of the present invention will be apparent in view of the following description.

### BRIEF DESCRIPTION OF THE DRAWINGS

Embodiments of the invention will now be described, by way of example, with reference to the accompanying drawings, in which:

FIG. 1 is a simplified diagram illustrating an exemplary switchable electrophoretic light modulator device in accordance with one or more embodiments.

FIG. 2 is a perspective view of a portion of an exemplary polymeric structure forming part of the electrophoretic ink layer of the light modulator device in accordance with one or more embodiments.

FIG. 3A is a simplified cross-sectional view of a portion of the light modulator device showing the device in a “closed” state in which the charged pigment particles are distributed across the cells of the device and absorb incident light.

FIG. 3B is a simplified cross-sectional view of a portion of the light modulator device in an “open” state in which the charged pigment particles concentrate in wells of the polymeric structure of the device.

FIG. 4A is a microscopic image illustrating simulated light output in a prior art light modulator film in an open state, and FIG. 4B shows an image viewed through the film.

FIG. 5A is a microscopic image illustrating simulated light output in a light modulator film in accordance with one or more embodiments in an open state, and FIG. 5B shows an image viewed through the film.

The drawing depict one or more implementations in accord with the present concepts, by way of example only, not by way of limitations.

### DETAILED DESCRIPTION

A switchable light modulating device with an electrophoretic fluid layer is disclosed in accordance with various embodiments. The device is configured to suppress aperture and array diffraction and thereby reduce blurring of images viewed through the device.

In one or more embodiments, the light modulating device is incorporated into a light control device. The light modulator selectively modifies one or more of light transmission, light attenuation, color, specular transmittance, specular reflectance, or diffuse reflectance in response to electrical signals, and switches to provide two or more different light states. In one or more embodiments, a first light state is transparent to visible light and corresponds to a maximum light transmission-a first extreme, i.e., “open” state, and a second light state corresponds to a minimum transmission-a second extreme, i.e., “closed” state. Of course, intermediate states are also possible, known as gray levels. Additionally, depending upon the electrophoretic medium pigment loading, a “closed” state may not be completely opaque, and an “open” state may not be completely transparent. Additionally, if the device is configured for use as a mirror or display, the “open” state may be colored or reflective.

The device includes an electrophoretic medium (i.e., electrophoretic ink) layer. The electrophoretic ink comprises colored, charged particles in a suspending fluid and is in contact with the surface of a non-planar, polymer structure. The colored, charged particles can be any color, including black or white. Preferably, the suspending fluid is transparent and refractive index matches the transparent, non-planar, polymer structure for at least one wavelength in the visible spectrum (typically 550 nm), and is a match or near match (i.e., within 0.01) for other visible light wavelengths. Consequently, in the absence of the colored charged particles, visible light rays (for the matched wavelength) experience negligible refraction at the interface between the suspending fluid and the non-planar, polymer structure.

The charged pigment particles may be of a variety of colors and compositions. In some embodiments, all of the charged particles, regardless of charge polarity, have the same or similar optical properties, such as color. In other embodiments, the first and second sets of oppositely charged particles may have different optical properties. In some embodiments, the first set of particles is colored (e.g., white or black) while the other set of particles is light-transmissive, and index-matched to meet the index of refraction of the internal phase of the electrophoretic medium. Additionally, the charged pigment particles may be functionalized with surface polymers to improve state stability. Such pigments are described, e.g., in U.S. Pat. No. 9,921,451, which is incorporated by reference in its entirety. For example, if the charged particles are of a white color, they may be formed from an inorganic pigment such as TiO₂, ZrO₂, ZnO, Al₂O₃, Sb₂O₃, BaSO₄, PbSO₄ or the like. They may also be polymer particles with a high refractive index (>1.5) and of a certain size (>100 nm) to exhibit a white color, to be substantially light-transmissive, or composite particles engineered to have a desired index of refraction. Such particles may include, e.g., poly(pentabromophenyl methacrylate), poly(2-vinylnapthalene), poly(naphthyl methacrylate), poly(alphamethylstyrene), poly(N-benzyl methacrylamide) or poly(benzyl methacrylate). Black charged particles may be formed from CI pigment black 26 or 28 or the like (e.g., manganese ferrite black spinel or copper chromite black spinel) or carbon black. Other colors (non-white and non-black) may be formed from organic pigments such as CI pigment PR 254, PR122, PR149, PG36, PG58, PG7, PB28, PB15: 3, PY83, PY138, PY150, PY155 or PY20. Other examples include Clariant Hostaperm Red D3G 70-EDS, Hostaperm Pink E-EDS, PV fast red D3G, Hostaperm red D3G 70, Hostaperm Blue B2G-EDS, Hostaperm Yellow H4G-EDS, Novoperm Yellow HR-70-EDS, Hostaperm Green GNX, BASF Irgazine red L 3630, Cinquasia Red L 4100 HD, and Irgazin Red L 3660 HD; Sun Chemical phthalocyanine blue, phthalocyanine green, diarylide yellow or diarylide AAOT yellow. Color particles can also be formed from inorganic pigments, such as CI pigment blue 28, CI pigment green 50, CI pigment yellow 227, and the like. The surface of the charged particles may be modified by known techniques based on the charge polarity and charge level of the particles required, as described in U.S. Pat. Nos. 6,822,782, 7,002,728, 9,366,935, and 9,372,380 as well as U.S. Patent Application Publication No. 2014-0011913, the contents of all of which are incorporated herein by reference in their entireties.

The particles may exhibit a native charge, or may be charged explicitly using a charge control agent, or may acquire a charge when suspended in a solvent or solvent mixture. Suitable charge control agents are well known in the art; they may be polymeric or non-polymeric in nature or may be ionic or non-ionic. Examples of charge control agent may include, but are not limited to, Solsperse 17000 (active polymeric dispersant), Solsperse 9000 (active polymeric dispersant), OLOA® 11000 (succinimide ashless dispersant), Unithox 750 (ethoxylates), Span 85 (sorbitan trioleate), Petronate L (sodium sulfonate), Alcolec LV30 (soy lecithin), Petrostep B100 (petroleum sulfonate) or B70 (barium sulfonate), Aerosol OT, polyisobutylene derivatives or poly(ethylene co-butylene) derivatives, and the like. In addition to the suspending fluid and charged pigment particles, internal phases may include stabilizers, surfactants and charge control agents. A stabilizing material may be adsorbed on the charged pigment particles when they are dispersed in the solvent. This stabilizing material keeps the particles separated from one another so that the variable transmission medium is substantially non-transmissive when the particles are in their dispersed state.

As is known in the art, dispersing charged particles (typically a carbon black, as described above) in a solvent of low dielectric constant may be assisted by the use of a surfactant. Such a surfactant typically comprises a polar “head group” and a non-polar “tail group” that is compatible with or soluble in the solvent. In some embodiments, it is preferred that the non-polar tail group be a saturated or unsaturated hydrocarbon moiety, or another group that is soluble in hydrocarbon solvents, such as, e.g., a poly(dialkylsiloxane). The polar group may be any polar organic functionality, including ionic materials such as ammonium, sulfonate or phosphonate salts, or acidic or basic groups. Particularly preferred head groups are carboxylic acid or carboxylate groups. In some embodiments, dispersants, such as polyisobutylene succinimide and/or sorbitan trioleate, and/or 2-hexyldecanoic acid are added.

The dispersion may contain one or more stabilizers. Stabilizers suitable for use in the dispersions made according to the various embodiments of the present invention include, but are not limited to, polyisobutylene and polystyrene. However, only a relatively low concentration of stabilizer may be necessary. A low concentration of stabilizer may assist in maintaining the media in the closed (opaque) or intermediate state, but the size of the hetero-agglomerates of the oppositely charged particles in the open state would be effectively stable without the presence of a stabilizer. For example, the dispersions incorporated in various embodiments may contain, with increasing preference in the amounts listed, less than or equal to 10%, 9%, 8%, 7%, 6%, 5%, 4%, 3%, 2%, and 1% stabilizer based on the weight of the dispersion. In some embodiments, the dispersion may be free of stabilizer.

The fluids used in the variable transmission media in various embodiments will typically be of low dielectric constant (preferably less than 10 and desirably less than 3). The fluids are preferably solvents that have low viscosity, relatively high refractive index, low cost, low reactivity, and low vapor pressure/high boiling point. The fluids are preferably light transmissive and may or may not have an optical property, such as color (e.g., red, green, blue, cyan, magenta, yellow, white, and black), that differs from the optical properties of at least one of the sets of charged particles of the dispersion. Examples of solvents include, but are not limited to, aliphatic hydrocarbons such as heptane, octane, and petroleum distillates such as Isopar® (Exxon Mobil) or Isane® (Total); terpenes such as limonene, e.g., 1-limonene; and aromatic hydrocarbons such as toluene. A particularly preferred solvent is limonene, since it combines a low dielectric constant (2.3) with a relatively high refractive index (1.47). The index of refraction of the internal phase may be modified with the addition of the index matching agents. For example, the aforementioned U.S. Pat. No. 7,679,814 describes an electrophoretic medium suitable for use in a variable transmission device in which the fluid surrounding the electrophoretic particles comprises a mixture of a partially hydrogenated aromatic hydrocarbon and a terpene, a preferred mixture being d-limonene and a partially hydrogenated terphenyl, available commercially as Cargille® 5040 from Cargille-Sacher Laboratories, 55 Commerce Rd, Cedar Grove N.J. 07009. In the encapsulated media made according to various embodiments of the present invention, it is preferred that the refractive index of the encapsulated dispersion match as closely as possible to that of the encapsulating material to reduce haze. In most instances, it is beneficial to have an internal phase with an index of refraction between 1.51 and 1.57 at 550 nm, preferably about 1.54 at 550 nm. In embodiments using a light-transmissive particle that is index matched to the internal phase, the light-transmissive particle will also have an index of refraction between 1.51 and 1.57 at 550 nm, preferably about 1.54 at 550 nm.

In one or more embodiments, the encapsulated fluid may comprise one or more nonconjugated olefinic hydrocarbons, preferably cyclic hydrocarbons. Examples of nonconjugated olefinic hydrocarbons include, but are not limited to, terpenes, such as limonene; phenyl cyclohexane; hexyl benzoate; cyclododecatriene; 1,5-dimethyl tetralin; partially hydrogenated terphenyl, such as Cargille® 5040; phenylmethylsiloxane oligomer; and combinations thereof. A most preferred composition for the encapsulated fluid according to some embodiments comprises cyclododecatriene and a partially hydrogenated terphenyl.

In one or more embodiments, the amount of stabilizing agent included in the encapsulated fluid may be lower than is traditionally used in electrophoretic displays. See, for contrast, U.S. Pat. No. 7,170,670. Such stabilizing agents may be large molecular weight free polymers such as polyisobutylene, polystyrene, or poly(lauryl)methacrylate. Accordingly, in some embodiments, the encapsulated fluid (i.e., dispersion) further comprises less than 10% of a stabilizing agent by weight of the dispersion. In some embodiments, the dispersion is free of the stabilizing agent. It is found that by reducing the presence of large molecular-weight polymers, the haze is improved, making the final product more pleasing.

In the first light state of embodiments, the charged particles respond to an electrical field applied to the electrodes to concentrate in volumes defined by the transparent, non-planar, polymer structure. In so concentrating the charged particles form (or expose) features that diffract light. These features are a plurality of apertures (i.e., optical openings) through which light travels, or obstructions (i.e., optical stops) around which light travels. Light diffracts at the circumference of both, and according to ‘Babinet's Principle’, the diffraction pattern from an opaque body (i.e., obstruction) is identical to that from a transparent opening (i.e., aperture) of the same size and shape except for the overall forward beam intensity (see “Babinet's Principle” in www.wikipedia.org; last accessed Sep. 23, 2021). In the first light state of embodiments, the concentrated charged particles form the apertures and/or obstructions that diffract light but the transparent microstructures of the non-planar, polymer structure define them.

In some embodiments, the electrophoretic medium is bistable in that the medium can maintain a desired optical state without the application of an electric field. For example, when apertures or obstructions of the first light state are bistable, power can be removed completely (i.e., zero volts between the first and second electrodes) after switching, and the apertures or obstructions remain unchanged. Similarly, the absence of apertures in the second light state, e.g., a light-absorbing or “closed” state is stable after switching and removal of power.

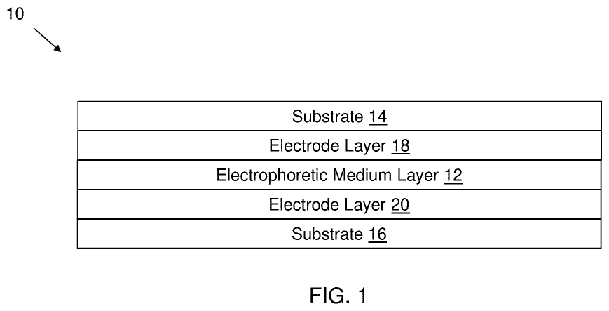

FIG. 1 is a simplified diagram illustrating an exemplary switchable electrophoretic light modulator device 10 in accordance with one or more embodiments. The device 10 includes an electrophoretic medium layer 12 positioned between a first light-transmissive substrate 14 and a second light-transmissive substrate 16. The major surfaces of the first and second light-transmissive substrates 14, 16 face each other and are juxtaposed parallel.

In one or more embodiments, the first light transmissive substrate 14 and the second light transmissive substrate 16 comprise polymers including acrylate, methacrylate, vinylbenzene, vinylether, or multifunctional epoxides.

A first transparent electrode layer 18 is positioned between the first light-transmissive substrate 14 and the electrophoretic medium layer 12. A second transparent electrode layer 20 is positioned between the second light-transmissive substrate 16 and the electrophoretic layer 12. In one or more embodiments, the electrode layers 18, 20 each comprise a transparent flexible Polyethylene Terephthalate (PET) film covered on its inner face with a transparent, flexible Indium Tin Oxide (ITO) electrode.

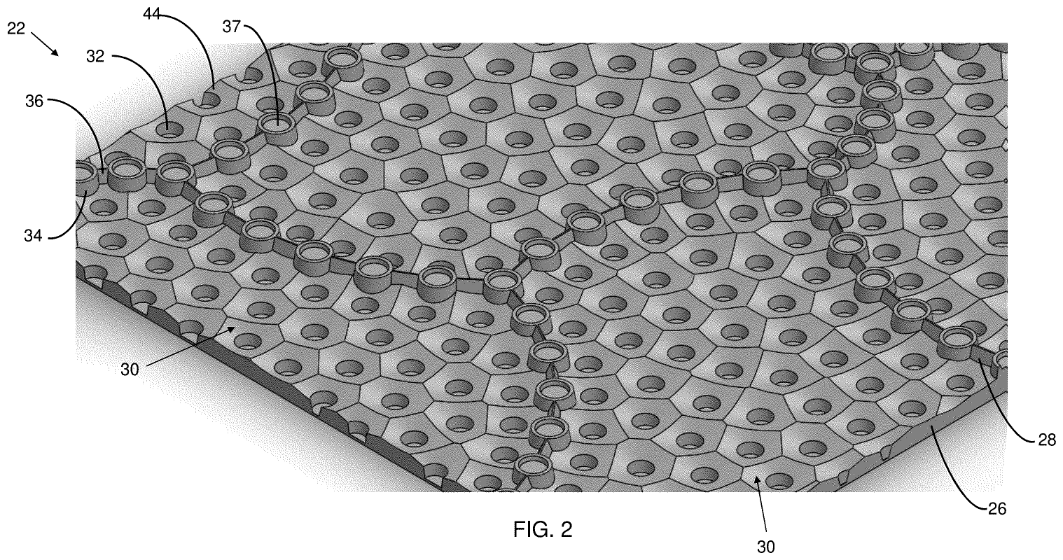

The electrophoretic layer 12 includes a light-transmissive polymeric structure 22 (e.g., as depicted in FIG. 2) on the electrode layer 20 and an electro-optic medium 24 contained in cells 30 defined by the polymeric structure 22. The polymeric structure 22 may be formed in an embossing process.

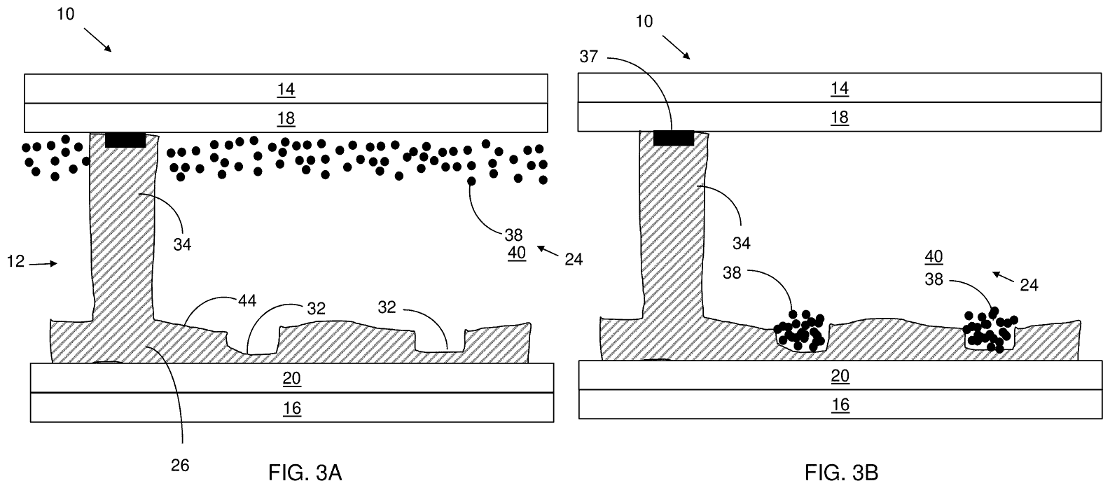

The electro-optic medium 24 comprises charged pigment particles 38 dispersed in a suspending fluid (e.g., a non-polar solvent) 40 as shown in FIGS. 3A and 3B. The charged particles 38 move through the suspending fluid 40 under the influence of an electric field. Applying a driving voltage between the first and second electrodes 18, 20 causes the electro-optic medium 24 in the electrophoretic layer 12 to switch between a first light-absorbing closed state (FIG. 3A) and a second light-transmissive open state (FIG. 3B) as discussed below.

As shown in FIG. 2, the polymeric structure 22 including a base 26 and a wall structure 28 extending from one surface of the base 26. The wall structure 28 defines multiple cells or volumes 30 for receiving and compartmentalizing the electro-optic medium 24. The base 26 of the polymeric structure 22 includes a plurality of wells 32 distributed across each of the cells 30 for receiving and concentrating charged pigment particles 38, thereby limiting the space occupied by the particles 38 in the second light-transmissive state (FIG. 3B). In one or more embodiments, the base 26 includes tapered surfaces 44 leading to each of the wells 32 to promote movement of the particles 38 into the wells 32 in the second light-transmissive state.

The wall structure 28 formed on the base 26 includes a plurality of pillar structures 34 and linking wall elements 36 connecting adjacent pillar structures 34. The pillar structures 34 each include a distal surface 37 parallel to the base 26. The distal surfaces 37 are preferably similar in size and shape to the plurality of wells 32. In one or more embodiments, the distal surfaces 37 of the pillar structures 34 are blackened (or otherwise colored) to resemble the wells 32 of the polymeric structure 22 when filled with pigment particles 38 in the second light-transmissive state.

By contrast, the distal surfaces of the linking wall elements 36 are light-transmissive and not blackened. Because the pillar structures 34 provide substantially all of the structural support and sealing adhesion for the polymeric structure 22, the linking wall elements 36 can have reduced thickness and a small surface area. For example, the total surface area of the linking wall elements 36 can be under 1% of the total area of the polymeric structure 22, so that even without blackened surfaces on the linking wall elements 36, the desired percent transmittance (% T) in the closed state will be within a desired range.

The distal surfaces 37 of the pillars 34 are arranged with the plurality of wells 32 across the surface of the polymeric structure 22 in a pre-determined pattern configured to suppress diffraction when the device 10 is in the light-transmissive open state. Various algorithms can be used to generate the pattern. In one or more embodiments, the pattern is generated using a blue noise algorithm, a dithering algorithm, a nonrepeating mono-tiles algorithm, an organic inspired algorithm such as phyllotactic spirals, or the like.

In some embodiments, the distal surfaces 37 of the pillar structures 34 are different in size or shape to the wells 32 in order to vary desired optical properties.

In one or more embodiments, the polymeric structure 22 includes additional pillar structures 34 that are free-standing, i.e., separate from the wall structure 28, to provide added structural support for sealing adhesion. Such pillars can be part of the predetermined pattern discussed above generated using a blue noise or other algorithm.

It should be noted that the figures, including FIG. 2, are not to scale. In some embodiments, the pitch of the wells 32 and the pillar distal surfaces 37 in the polymeric structure 22 is from 50 microns to 5,000 microns. For example, a smart glass device incorporating the light modulator 10 with a well pitch of 250 microns would typically have between 2,000 and 6,000 wells 32 across its face, and from 2,000 to 20,000 along its face, or a total number in the array of between 4 million and 120 million.

The following two examples show possible approximate dimensions of polymeric structure features.

| Dimension | Example 1 | Example 2 |
|---|---|---|
| Depth of wells | 8 um | 8 um |
| Diameter of wells | 11 um | 15 um |
| Number of wells per cell | 64 | 119 |
| Number of wells in 0.5 m² area | 333,000,000 | 618,000,000 |
| Distance from well base to pillar top | 20 um | 20 um |
| Average pillar height | 8 um | 8 um |
| Linking wall thickness at top | 1 um | 1 um |
| Linking wall thickness at base | 15 um | 15 um |
| Linking wall height | 8 um | 8 um |

FIG. 3A is a cross-sectional view of a portion of the light modulator device 10 in the dark (closed) state, in which the charged pigment particles 38 in the electro-optic medium 24 are spread across the viewing face and adjacent the inner face of the electrode layer 18. The charged pigment particles 38 absorb light incident on the device 10.

FIG. 3B shows the light modulator device 10 in the open state, in which the charged pigment particles 38 are concentrated in the wells 32 of the polymeric structure 22.

The open state forms when a voltage having the opposite polarity to that of the charged particles 38 is applied to the electrode 20 on the substrate 16 to form an electrical field between the opposing electrodes 18, 20. The electrical field drives the charged particles 38 toward the inner face of the substrate 16 and, on encountering the tapered surfaces 44, the particles 38 migrate to concentrate in the wells 32. The depth of the wells 32 is sufficient to hold the concentrated particles 38 in the open state. It is dependent on the volume needed by the particles 38 to concentrate, and in turn is dependent on the particle loading in the ink's suspending fluid. The latter determines the light transmission in the dark state. The closed state (FIG. 3A) forms when the polarity of the voltage is reversed, attracting the charged particles 38 to the inner face of the substrate 14 where they spread adjacent its electrode 18. The forming of light states in an electrophoretic device using protrusions is described in more detail in the Applicant's U.S. Pat. No. 10,067,398 titled “An Electrophoretic Device Having a Transparent Light State”. It is understood that the charged particles 38 may be driven with time varying voltages, e.g., waveforms that may range in voltage from 0 to ±500V, although typically less.

The electro-optic medium 24 and the polymeric structure 22 are preferably optically transparent and a refractive index match. This allows light incident on device 10, not otherwise absorbed by the pigment particles 38, to be transmitted unhindered (i.e., not refracted or diffracted) by the interface between the suspending fluid of the electro-optic medium 24 and the polymeric structure 22.

In one or more embodiments, a scaling layer having, e.g., a polymeric composition, is applied over the polymeric structure 22 to seal the electro-optic medium 24 in the plurality of cells 30. The pillar structures 34 provide structural support and sealing adhesion to the scaling layer.

Additionally, one or more layers of adhesive, such as an optically-clear adhesive available, e.g., from Norland, may be used to bond various films and structures to one another.

In one or more embodiments, the switchable light modulator 10 is implemented in a windshield, window, glasses, googles, or visor.

In one or more embodiments, the switchable light modulator 10 is implemented in an information display system. The system comprises a transparent substrate, the switchable light modulator, and a projector configured to project information on the switchable light modulator. In one or more embodiments, the projector is a near-to-eye projector.

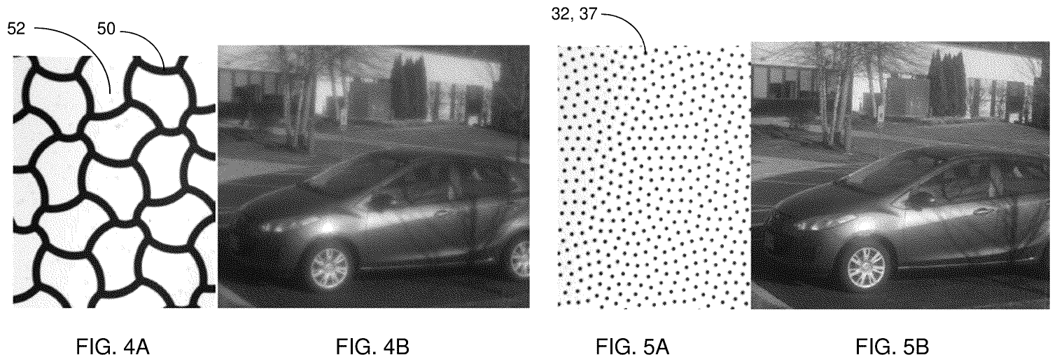

FIG. 4A is a microscopic image illustrating light output in a prior art light modulator film in an open state, and FIG. 4B is a photograph showing an image viewed through the film. The prior art light modulator film includes a polymeric structure having a wall structure 50 defining a plurality of cells containing electrophoretic fluid. The top surface of the wall structure 50 is blackened in order to achieve a desired percent transmittance (% T) under 1% in the closed state. The blackened wall surfaces define apertures 52 in the open state as shown in FIG. 4A. The apertures 52 introduce diffraction especially when a bright light source is viewed through the film, resulting in image blurriness as shown in FIG. 4B.

FIG. 5A is a microscopic image showing light output in a light modulator film 10 in accordance with one or more embodiments in the open state. Instead of a set of apertures, the film produces a blue noise (or other) field of dots formed by the combination of the pigment-filled wells 32 and blackened pillar surfaces 37. The field of dots suppresses diffraction and thereby reduces image blurriness as shown in the FIG. 5B image viewed through the film.

As discussed above, diffraction refers to various phenomena arising from the wave nature of light. It describes the apparent bending of light waves around an obstruction and the spreading out of light waves past apertures. Many of the applications contemplated herein, such as variable light transmittance films for use in windows, are viewed from a distance of one meter or more, and the scene visible through an embodiment will be at a distance of 10 meters or more, typically. In such cases the diffraction pattern (where present) is known as Fraunhofer diffraction (i.e., far field conditions). If the object and viewing distances are less than one meter then the pattern (where present) can fulfil the conditions for Fresnel diffraction (i.e., near-field diffraction), see the relevant entries in www.wikipedia.org for example. The condition for Fraunhofer diffraction is dependent on the major axis of an aperture (or obstruction), the viewing distance needs to be far greater than the major axis (for more information see the “Fraunhofer Diffraction” entry in www.wikipedia.org).

In general, diffraction in embodiments is in relation to visible light, even though devices described minimize diffraction of light across the sunlight spectrum including the infrared. Diffraction occurs in embodiments at the edge of light transmitting and obstructing areas, or, at the edge between two transparent area having different refractive indices (i.e., light traveling at different speeds). The obstruction of light can be caused by concentrated charged particles 38 substantially absorbing it, or concentrated charged particles 38 causing a change in refractive index as well as light attenuation. In other embodiments, the obstruction of light by concentrated charged particles 38 includes by diffuse or specular reflection.

Embodiments of the device regulate light transmission and/or visual access when incorporated into a window of a building, including single, double, and triple glazed windows. In the latter two, the device is preferably located in a pane adjacent the outside environment so that absorbed sunlight energy can be dissipated by convection and thermal radiation to the outside environment. In other window and/or opening embodiments, the device regulates the transmission of sunlight into the interior of an automobile or public transport vehicle (e.g., bus, train, tram, ferry, or ship), minimizes glare, and provides a degree of privacy for occupants from outside viewers while maintaining visibility of the outside for occupants. Yet other embodiments include use as a light shutter, a light attenuator, a variable light transmittance sheet, a variable light absorptance sheet, a variable light reflectance sheet, a one-way mirror, a sunvisor, or a skylight.

In some embodiments an electrophoretic ink fills the cavities in a laminating step that applies the embossed polymer structure previously formed on (and bonded to) the first substrate, to the second substrate, with the ink layer between. Preferably, the laminating step uses a pair of NIP rollers orientated so that the substrates travel from top-to-bottom (as opposed to left-to-right) between the rollers. The fluid is in a bead between the substrates above the NIP point and laminated by the rollers into the cavities in the embossed polymer as the substrates pass the NIP point. The orthogonal distance between the parallel faces of the substrates is determined by the polymer wall structures as the substrates pass the NIP point. Preferably, the tops of the polymer wall are bonded to the second substrate in a UV light (or other radiation) cure stage after or contemporaneously with laminating.

In some embodiments, the device has flexible film substrates and is sufficiently flexible to be compatible with roll-to-roll manufacture. The film device has significant structural strength and compartmentalizes the fluid layer in cavities with each cavity holding a discrete ink volume that is self-sealed and isolated from adjacent cavities. The structural strength of embodiments derives from the selection of its polymer structure and polymer sealing materials. The structural strength includes that necessary to withstand being permanently laminated to glass panes in a laminated safety glass comprising either EVA or PVB interlayers as optical adhesive between the device and glass panes. The device's materials are selected to have resistance to mechanical shocks and environmental extremes (sunlight and outdoor temperature) in normal use.

It will be apparent to those skilled in the art that numerous changes and modifications can be made in the specific embodiments of the present invention described above without departing from the scope of the invention. Accordingly, the whole of the foregoing description is to be construed in an illustrative and not in a limitative sense.

1. A switchable light modulator, comprising:
a first light-transmissive substrate;
a first electrode on one side of the first light-transmissive substrate;
a second light-transmissive substrate;
a second electrode on one side of the second light-transmissive substrate;
a light-transmissive polymeric structure between the first electrode and the second electrode, the polymeric structure including a base and a wall structure extending from the base defining a plurality of cells, each cell including a plurality of wells on the base, the wall structure comprising a plurality of pillar structures and linking wall elements connecting adjacent pillar structures, and wherein the pillar structures include distal surfaces parallel to the base, said distal surfaces being arranged with the plurality of wells in a given pattern; and
an electro-optic medium contained in each of the plurality of cells;
wherein application of a driving voltage between the first and second electrodes causes the electro-optic medium to switch between a first light-absorbing state and a second light-transmissive state.

2. The switchable light modulator of claim 1, wherein the electro-optic medium comprises charged pigment particles dispersed in a non-polar solvent, and the electro-optic medium switches between the first light-absorbing state and the second light-transmissive state by moving between a distributed particle state and an assembled particle state.

3. The switchable light modulator of claim 2, wherein when the electro-optic medium is in the second light-transmissive state, the charged pigment particles are collected in the wells of the polymeric structure, and when the electro-optic medium is in the first light-absorbing state, the charged pigment particles are distributed across the cells.

4. The switchable light modulator of claim 1, wherein the distal surfaces of the pillar structures are blackened.

5. The switchable light modulator of claim 1, wherein distal surfaces of the linking wall elements are light-transmissive.

6. The switchable light modulator of claim 1, wherein the electro-optic medium is bistable.

7. The switchable light modulator of claim 1, wherein the given pattern is generated using a blue noise algorithm, a dithering algorithm, a nonrepeating mono-tiles algorithm, or an organic inspired algorithm.

8. The switchable light modulator of claim 1, further comprising a sealing layer applied over the polymeric structure to seal the plurality of cells, wherein the pillar structures provide structural support and sealing adhesion to the sealing layer.

9. The switchable light modulator of claim 1, wherein the distal surfaces of the pillar structures are similar in size and shape to the plurality of wells.

10. The switchable light modulator of claim 1, wherein the distal surfaces of the pillar structures are dissimilar in size or shape to the plurality of wells.

11. The switchable light modulator of claim 1, wherein said polymeric structure is embossed.

12. The switchable light modulator of claim 1, wherein the first light transmissive substrate or the second light transmissive substrate comprise polymers including acrylate, methacrylate, vinylbenzene, vinylether, urethanes, or multifunctional epoxides.

13. A windshield, window, glasses, googles, or visor including the switchable light modulator of claim 1.

14. An information display system comprising a transparent substrate, the switchable light modulator according to claim 1, and a projector configured to project information on the switchable light modulator.

15. The information display system of claim 14, wherein the projector is a near-to-eye projector.

16. A method comprising:
providing a switchable light modulator, comprising a first light-transmissive substrate, a first electrode on one side of the first light-transmissive substrate, a second light-transmissive substrate, a second electrode on one side of the second light-transmissive substrate, a light-transmissive polymeric structure between the first electrode and the second electrode, and an electro-optic medium contained in a plurality of cells in the polymeric structure, wherein the electro-optic medium comprises charged pigment particles dispersed in a non-polar solvent, and wherein the polymeric structure includes a base and a wall structure extending from the base defining the plurality of cells, each cell including a plurality of wells on the base, the wall structure comprising a plurality of pillar structures and linking wall elements connecting adjacent pillar structures, and wherein the pillar structures include distal surfaces parallel to the base, said distal surfaces being arranged with the plurality of wells in a given pattern; and
applying a driving voltage between the first and second electrodes to cause the electro-optic medium to switch between a first light-absorbing state and a second light-transmissive state, wherein the electro-optic medium switches between the first light-absorbing state and the second light-transmissive state by moving between a distributed particle state and an assembled particle state, and wherein when the electro-optic medium is in the second light-transmissive state, the charged pigment particles are collected in the wells of the polymeric structure, and when the electro-optic medium is in the first light-absorbing state, the charged pigment particles are distributed across the cells.

17. The method of claim 16, wherein the distal surfaces of the pillar structures are blackened.

18. The method of claim 16, wherein distal surfaces of the linking wall elements are light-transmissive.

19. The method of claim 16, wherein the electro-optic medium is bistable.

20. The method of claim 16, wherein the given pattern is generated using a blue noise algorithm, a dithering algorithm, a nonrepeating mono-tiles algorithm, or an organic inspired algorithm.

21. The method of claim 16, wherein the switchable light modulator further comprises a sealing layer applied over the polymeric structure to seal the plurality of cells, wherein the pillar structures provide structural support and sealing adhesion to the sealing layer.

22. The method of claim 16, wherein the distal surfaces of the pillar structures are similar in size and shape to the plurality of wells.

23. The method of claim 16, wherein the distal surfaces of the pillar structures are dissimilar in size or shape to the plurality of wells.

24. The method of claim 16, wherein said polymeric structure is embossed.

25. The method of claim 16, wherein the first light transmissive substrate or the second light transmissive substrate comprise polymers including acrylate, methacrylate, vinylbenzene, vinylether, or multifunctional epoxides.
